(19) United States
(12) Patent Application Publication
(10) Pub. No.: US 2026/0017524 A1
(43) Pub. Date: Jan. 15, 2026

(54) TRAINING OF A MACHINE LEARNING MODEL FOR PREDICTIVE MAINTENANCE TASKS

(71) Applicants: Continental Automotive Technologies GmbH, Hannover (DE); NANYANG TECHNOLOGICAL UNIVERSITY, SINGAPORE (SG)

(72) Inventors: Shen Ren, Singapore (SG); Wen Zheng Terence Ng, Singapore (SG); Sinno Jialin Pan, Singapore (SG)

(73) Assignees: Continental Automotive Technologies GmbH, Hannover (DE); NANYANG TECHNOLOGICAL UNIVERSITY, SINGAPORE (SG)

(21) Appl. No.: 18/993,783

(22) PCT Filed: Apr. 13, 2023
(86) PCT No.: PCT/EP2023/059601

§ 371 Date: Jan. 13, 2025

(30) Foreign Application Priority Data
Jul. 13, 2022 (GB) 2210261.0

(51) Int. Cl. G06N 3/0895; G06F 11/00; G06N 3/0455

(52) U.S. Cl. CPC G06N 3/0895; G06F 11/004; G06N 3/0455; G06F 2201/805

(57) ABSTRACT

A computer-implemented method for training a representation learning model to be able to determine predictive maintenance data from irregular-sampled, and variable-length timeseries data includes providing unlabeled timeseries data indicative of a state of a device under surveillance; embedding the timeseries data that generates embedded timeseries data indicative of the relative temporal distance of the entries relative to each other; performing a first training of the representation learning model by masking a predetermined number of temporally consecutive pieces of observation data; attaching to the representation learning model a fully-connected layer that normalizes a representation learning model output and feeds the normalized output to a loss model that is indicative of a specific predictive maintenance task; and performing a second training of the representation learning model based on the loss model and sparsely labelled timeseries data in order to obtain a trained representation learning model for determining predictive maintenance data.

### CROSS-REFERENCE TO RELATED APPLICATIONS

The present application is a National Stage Application under 35 U.S.C. § 371 of International Patent Application No. PCT/EP2023/059601 filed on Apr. 13, 2023, and claim priority from Great Britian Patent Application No. 2210261.0 filed on Jul. 13, 2022, in the United Kingdom Intellectual Property Office, the disclosures of which are herein incorporated by reference in their entireties.

### TECHNICAL FIELD

The invention relates to a computer-implemented method for training a representation learning model to be able to determine predictive maintenance data. The invention further relates to the application of such a trained representation learning model.

### BACKGROUND

In industry, any unscheduled downtime or outage of systems and machinery may become a significant disruption of a company's core business, leading to dramatical financial losses or reputational damages. For example, an outage of merely 63 minutes cost Amazon nearly $100 million in lost sales in 2018. On the other hand, over-maintenance also has huge financial impact-around 33 cents of every dollar spent on maintenance are wasted for unnecessary maintenance activities according to US surveys. This brings up the significance of designing an efficient and effective maintenance strategy.

Maintenance is traditionally performed by reactive maintenance or preventive maintenance, which either fix the system after a failure occurred or maintain the system regularly following some schedules or conditions. With the development of big data, internet of things, advanced sensory technologies and machine learning, predictive maintenance (PdM) has come up as a new concept to make predictions of future failures based on past and current operational conditions, so as to avoid both under-maintenance and over-maintenance.

US 2020/0 380 336 A1 discloses a method for a hardware component failure prediction system that can incorporate a timeseries dimension as an input while also addressing issues related to a class imbalance problem associated with failure data. The training dataset is augmented by adding synthetically repetitive samples. Embodiments utilize a double-stacked long short-term memory (DS-LSTM) deep neural network that typically are incapable of handling irregular-sampled timeseries.

US 2020/0 166 922 A1 discloses an industrial machine predictive maintenance system. The system includes an industrial machine predictive maintenance facility that produces industrial machine service recommendations responsive to health monitoring data by applying machine fault detection and classification algorithms.

US 2020/0 143 252 A1 discloses techniques for performing finite rank deep kernel learning. In one example, a method for performing finite rank deep kernel learning includes receiving a training dataset; forming a set of embeddings by subjecting the training data set to a deep neural network; forming, from the set of embeddings, a plurality of dot kernels; combining the plurality of dot kernels to form a composite kernel for a Gaussian process; receiving live data from an application; and predicting a plurality of values and a plurality of uncertainties associated with the plurality of values simultaneously using the composite kernel.

US 2020/0 074 275 A1 discloses a for detecting and correcting anomalies on timeseries data by comparing a new timeseries segment, generated by a sensor in a cyber-physical system, to previous timeseries segments of the sensor to generate a similarity measure for each previous timeseries segment. It is determined that the new timeseries represents anomalous behavior based on the similarity measures. A corrective action is performed on the cyber-physical system to correct the anomalous behavior.

US 2017/0 372 224 A1 discloses a method for imputing multivariate-timeseries data in a predictive model.

According to Franceschi et al., “Unsupervised scalable representation learning for multivariate timeseries”, arXiv preprint arXiv: 1901.10738 (2019), timeseries constitute a challenging data type for machine learning algorithms, due to their highly variable lengths and sparse labeling in practice. They propose an unsupervised method to learn universal embeddings of timeseries and combine an encoder based on causal dilated convolutions with a novel triplet loss employing time-based negative sampling, obtaining general-purpose representations for variable length and multivariate timeseries.

Raffel, Colin, et al. “Exploring the limits of transfer learning with a unified text-to-text transformer”, arXiv preprint arXiv: 1910.10683 (2019), discuss transfer learning in the context of natural language processing (NLP), where a model is first pre-trained on a data-rich task before being fine-tuned on a downstream task. A unified is used framework to convert all text-based language problems into a text-to-text format.

da Costa et al. “Attention and long short-term memory network for remaining useful lifetime predictions of turbofan engine degradation”, International Journal of Prognostics and Health Management 10 (2019): 034 discloses machine prognostics and health management (PHM) that is concerned with the prediction of the remaining useful lifetime (RUL) of assets. They propose a long short-term memory (LSTM) network combined with global attention mechanisms to learn RUL relationships directly from timeseries sensor data.

US 2019/0 235 484 A1 discloses a system for maintenance predictions generated using a single deep learning architecture. The example implementations can involve managing a single deep learning architecture for three modes including a failure prediction mode, a remaining useful life (RUL) mode, and a unified mode. Each mode is associated with an objective function and a transformation function. The single deep learning architecture is applied to learn parameters for an objective function through execution of a transformation function associated with a selected mode using historical data. The learned parameters of the single deep learning architecture can be applied with streaming data from the equipment to generate a maintenance prediction for the equipment.

Predictive maintenance is known to help improving the uptime of machinery, reducing management costs, mitigating safety, health, environmental and quality risks, and extending the lifetime of aging assets.

While the PdM concept has been popular for many years, it has not been widely adopted over conventional reactive/preventive maintenance strategies. One reason behind that can be seen in the subtle trade-off between cost and reliability. PdM typically involves an entire framework of both hardware and software for condition monitoring, data pipeline and (pre) processing, as well as advanced machine/deep learning algorithms for fault diagnosis and prognosis. Among them, the machine learning algorithms are the central processing unit for PdM, but there is no free lunch available to make reliable predictions from nothing.

The predictive abilities of all machine learning or deep learning algorithms are currently heavily constrained by the quality and the amount of available historical data and failure labels, which are notoriously difficult and expensive to obtain. In most of the cases, to collect “machine failure” labels, the machines would have to be operated for a prolonged time until they fail.

As of yet, there seems to be no cost-effective or simple way for collecting real-world failure data and labelling them accordingly. At the same time, consistently sampling, aligning, transmitting, and storing high-frequency multivariate timeseries that can be used in state-of-the-art deep learning models are costly (both in effort and in money). Due to economic considerations or restrictions, in practice, a lot of the real-world predictive maintenance datasets collected as multivariate timeseries are rarely labelled, sparsely collected, irregular sampled and with variable length.

There are some limited state-of-the-art studies in this field designing cost-effective deep learning algorithms for PdM to make use of practical datasets (multivariate, irregular-sample timeseries data collected from multiple sensors) and to reduce the number of expensive labels required (run-to-failure historical records).

Conventionally, the problem of a cost-effective design of PdM solution is either approached from system architecture perspective (standardization, making sure of on-demand cloud services, using a digital twin model, etc.), or multi-objective optimization perspective to find a better trade-off among multiple objectives (e.g., maintenance costs, operational costs, reliability, etc.) at a strategy level.

The recent development of deep learning has opened new possibilities of designing better performed predictive algorithms for PdM. Various deep learning models including auto-encoder (AE), convolutional neural network (CNN), recurrent neural network (RNN), deep belief network (DBN), generative adversarial network (GAN), transfer learning, and deep reinforcement learning (DRL) have been applied to PdM. However, except for a few of them the current deep learning based PdM methods mainly aim for better performance given a massive amount of historical failure examples, or concentrate only on degradation process estimation task which does not require abundant failure labels.

Typical state-of-the-art deep learning based PdM approaches aim for improved performance in prediction assuming sufficient failure labels. This usually ignores the fact that PdM is intended to save costs in maintenance which is in conflict with necessary collecting and storing of massive amounts of historical failure data for these kinds of approaches.

Some progress was made by deep learning approaches that are aware of the limitation of failure labels in PdM. The common issue is to try to achieve a more cost-effective PdM by reducing the expensive labels to be used. One solution is based on producing realistic synthesized failure data via GANs. Another solution includes the use transfer learning to adapt the failure data collected from a source domain to closely related target domains.

Both approaches allow a reduction of the number of failure labels required for deep learning by either data augmentation (GAN) or domain adaptation from other related datasets (transfer learning). However, the first approach, GAN can be unstable in the training phase and it is possible that the synthetic failure data generated from GAN may deteriorate the model performance. While the second approach may allow a reduction of failure labels in the target domain, abundant failure labels are typically still needed in source domain. In addition the source domain and the target domain need to be sufficiently related or “close enough” to avoid negative transfer.

Also, in PdM research there seems to be no deep learning model designed to improve on learning timeseries with inconsistent time intervals between samples (irregular-sampled timeseries). This, however, is ubiquitous in practice. The current models in PdM mainly include a pre-processing stage to discard erroneous data and clean the data for a consistent sampling rate before applying deep learning model, or simply train and test models on publicly available clean dataset.

Out of the domain of PdM, the problem of reducing labels and the problem of irregular-sampled timeseries are separately addressed by two research communities. Beyond the kernel methods used in signal processing and traditional machine learning, for deep learning, the promising approach for label-efficient learning is thought to be through unsupervised representation learning, which does not account for irregular-sampled timeseries.

On the other hand, the methods addressing irregular-sampled timeseries are not meant for unsupervised representation learning as a pre-training to reduce supervised labels. This motivates the measures described herein to address both label issue and irregular-sampled timeseries issue, and allow an application to PdM for practical usage.

### SUMMARY

It is the object of the present disclosure to disclose improved measures for predictive maintenance tasks that are better able to make use of typical real world timeseries data.

The present disclosure provides a computer-implemented method for training a representation learning model to be able to determine predictive maintenance data from irregular-sampled, and variable-length timeseries data that is indicative of a state of a device under surveillance, the method including:
a) obtaining or providing unlabeled timeseries data that are indicative of a state of the device under surveillance and that include a plurality of entries each entry including a timestamp and at least one piece of observation data that is indicative of a physical property of the device under surveillance and that is associated with the timestamp;
b) performing an embedding of the timeseries data of step a) that generates embedded timeseries data that are indicative of the relative temporal distance of the entries relative to each other;
c) performing a first training of the representation learning model, the representation learning model having at least one encoder layer and at least one decoder layer, wherein a last encoder layer feeds into a first decoder layer, by masking in the embedded timeseries data a predetermined number of temporally consecutive pieces of observation data so as to obtain masked embedded timeseries data and training the representation learning model to recover the masked consecutive pieces of observation data;
d) attaching to the representation learning model a fully-connected layer that normalizes an output of the representation learning model and feeds the normalized output to at least one loss model that is indicative of a specific predictive maintenance task; and
e) performing a second training of the representation learning model based on the at least one loss model of step d) and sparsely labelled timeseries data in order to obtain a trained representation learning model that is able to determine predictive maintenance data.

Sparsely labelled timeseries data usually means that less than half, such as less than a quarter, and more particularly less than a tenth of the entries have a label different from a default label.

In step a), the unlabeled timeseries data are gathered by a sensor device that is arranged to measure a physical property of the device under surveillance.

Step b) may include generating directed graph data from the entries. The directed graph data may be structured to represent a plurality of nodes that are linked with edges. A first node may be assigned the observation data that are associated with a first timestamp and a second node is assigned the observation data that are associated with a second timestamp that is different from the first timestamp. An edge connecting the first node with the second node may be assigned an edge value that is indicative of the relative temporal distance between the first timestamp and the second timestamp.

Determining the relative time difference includes calculating the logarithm of a time difference between the first and second timestamps. Determining the relative time difference includes calculating the logarithm of the square of a time difference between the first and second timestamps.

The time difference is divided by a predetermined constant that is chosen to be equal to or smaller than a minimum sampling interval of the timeseries data.

The time difference is divided by another predetermined constant that is chosen to represent a time period that is present unlabeled in the timeseries data due to cyclical operation of the device under surveillance.

In step c), the representation learning model includes a fully-connected neural network layer as an input layer that gets fed with the masked embedded timeseries data and passes its output to a first encoder layer.

In step d), the representation learning model includes a fully-connected neural network layer as an input layer that gets fed with the masked embedded timeseries data and passes its output to a first encoder layer.

In step c), the representation learning model includes a fully-connected neural network layer as an output layer that gets fed with the output of a last decoder layer and passes its output to the loss function of the first training.

In step d), the representation learning model includes a fully-connected neural network layer as an output layer that gets fed with the output of a last decoder layer and passes its output to the fully-connected layer.

In step d), each loss model is chosen from a group consisting of a loss function that is indicative of anomalous observation data, a loss function that is indicative of a class of failure, and a loss function that is indicative of a remaining useful lifetime.

In step d), a first loss model and a second loss model that are different from each other are chosen, wherein a multi-task training loss is determined based on the respective output of the loss models, and the multi-task training loss is used in step e) for the second training.

The representation learning model is an encoder-decoder transformer model.

The present disclosure provides a predictive maintenance method including:
a) gathering timeseries data that is indicative of a physical property of a device under surveillance, using a sensor that is arranged to monitor the device under surveillance;
b) feeding the timeseries data to a representation learning model that was trained according to an example method; and
c) determining with the trained representation learning model predictive maintenance data that are indicative of maintenance tasks, such as determining an anomalous operation of the device under surveillance, determining a class of failure occurring in the device under surveillance, and/or determining a remaining useful lifetime of the device under surveillance.

The present disclosure provides an encoder-decoder transformer model that was trained with a method described above.

The present disclosure provides a data processing system including means for carrying out at least one, some, or all steps of an example method.

The data processing system includes means for carrying out steps b) and/or c) of the predictive maintenance method.

The present disclosure provides a computer program including instructions which, when the program is executed by a data processing system cause the system to carry out at least one, some, or all steps of an example method.

The computer program includes instructions for carrying out steps b) and/or c) of the predictive maintenance method.

The present disclosure provides a computer-readable data carrier or a data carrier signal that includes the computer program.

One idea is a design to improve the deep learning methods for PdM, so as to push the boundary of cost-reliability trade-off a bit further. With the disclosed measures it is possible to use ubiquitous, less-structured—and thus inexpensive sensory data—to gain insights for reducing the number of expensive failure labels needed. A practical and less expensive design of PdM can be achieved via the label efficient PdM methods disclosed herein.

A main technical challenge to be improved is the modelling of sparsely labelled timeseries data that is multivariate, sparse, and irregular-sampled with highly variable length. This kind of timeseries data is almost ubiquitous in practical predictive maintenance applications. The modelling of the timeseries can serve multiple predictive maintenance tasks, including—but not necessarily limited to—anomaly detection, classification of failures, and prediction of remaining useful life (RUL).

With the disclosed ideas the following issues can be improved (not necessarily at the same time or by the same amount):

Modelling of irregular-sampled timeseries data with variable length by deep learning models.

Learning representations from such a dataset that is rarely or sparsely labelled, for multivariate timeseries datasets in predictive maintenance, and the labelling process.

An end-to-end design of a predictive maintenance framework that allows handling of multiple related predictive maintenance tasks at the same time, by sharing and reusing appropriate datasets.

Thus, it is possible to handle more realistic multivariate timeseries failure datasets using deep learning models in practice, and to reduce labels needed for supervised learning, by learning representations following an unsupervised method.

The ideas described herein can be applied to multiple PdM tasks. Potentially, the embodiments according to the present disclosure can also be used to learn representations from multivariate timeseries in a great variety of domains and applications including robotics, biology, healthcare, and others.

One idea is to introduce a relative time embedding for sparse, irregular-sampled, and variable-length timeseries.

This idea focuses on relative time embedding to capture temporal information of sparse, irregular-sampled, and variable-length timeseries for better representations in self-attention models.

Considering scaled dot-product attention used in a transformer model, where Q, K, V are some hidden states representation specified as query, key and value, and/is the dimensionality of the hidden representation. The attention module could be mathematically represented as

$$Attention ( Q , K , V ) = softmax ( \frac{Q {K}^{T}}{\sqrt{l}} ) V$$

More specifically, the self-attention module with absolute positional encoding as real-valued vector pᵢ for input sequence xᵢ can be represented as

$$\{ \begin{matrix}{q}_{i} = ( {x}_{i} + {p}_{i} ) {W}_{Q} \\ {k}_{j} = ( {x}_{j} + {p}_{j} ) {W}_{K} \\ {v}_{j} = ( {x}_{j} + {p}_{j} ) {W}_{V} \\ {a}_{i , j} = softmax ( \frac{{q}_{i} {k}_{j}^{T}}{\sqrt{l}} ) \\ {o}_{i} = {\sum }_{j} {a}_{i , j} {v}_{j}\end{matrix}$$

where j represents the position of the sample that is attended to, W_{Q}, W_{K}, and W_{V} are weight matrices and T indicates transposition (i.e., swapping rows and columns).

While n is a constant, before softmax,

$${q}_{i} {k}_{j}^{T} = ( {x}_{i} + {p}_{i} ) {W}_{Q} {{W}_{K}^{T} ( {x}_{j} + {p}_{j} )}^{T}$$

Expansion of this representation shows that the terms

$${x}_{i} {W}_{Q} {W}_{K}^{T} {p}_{j}^{T} and {p}_{i} {W}_{Q} {W}_{K}^{T} {x}_{j}^{T}$$

describe a relationship between sequence embedding and positional embedding, which is theorized and experimentally shown to have little correlations. In this way, these two terms can be removed in our representation, so that the sequence embedding is represented by the term

$${x}_{i} {W}_{Q} {W}_{K}^{T} {x}_{j}^{T}$$

and the positional information is embedded in the term

$${p}_{i} {W}_{Q} {W}_{K}^{T} {p}_{j}^{T} ,$$

which should be a scalar.

Domain knowledge may be incorporated to directly model the relationship between the timestamps of “key” and “query” for irregular sampled timeseries.

The input multivariate timeseries is represented as a directed graph where the nodes represent sample values and the edges represent the relative temporal difference between each pair of samples. The edge values can be directly used as relative positional embedding to replace the term

$${p}_{i} {W}_{Q} {W}_{K}^{T} {p}_{j}^{T} .$$

One straight-forward form is to calculate the absolute time difference between each pair of samples, scale them accordingly with logarithmic growth and assign each edge value, where λ is a constant as a scale factor. The scale factor may be chosen to be equal to or smaller than the minimum sampling interval, and/or set

$${log}_{2} ( \frac{{t}_{j} - {t}_{i}}{λ} ) to 0 if \frac{{t}_{j} - {t}_{i}}{λ} < 1 ,$$

where tᵢ, tⱼ are timestamps of “query” and “key” accordingly. Consequently, the embedding is based on:

$${q}_{i} {k}_{j}^{T} = {x}_{i} {W}_{Q} {W}_{K}^{T} {x}_{j}^{T} + {log}_{2} ( \frac{{t}_{j} - {t}_{i}}{λ} )$$

This embedding was found to work for modelling irregular-sampled timeseries. The rationale to use the logarithmic function is to simulate the major benefit of sinusoidal positional encoding used in a vanilla transformer model, which allows to decrease the positional correlation between “key” and “query” close to an exponential decay.

Another example approach is to model periodic patterns that usually exists in timeseries data (such as a machine operational cycle) by modifying the above equation with a constant T that represents the period in the timeseries, so that the timestamps in same temporal position among different periods are closer to each other.

$${q}_{i} {k}_{j}^{T} = {x}_{i} {W}_{Q} {W}_{K}^{T} {x}_{j}^{T} + {log}_{2} ( \frac{{( {t}_{j} - {t}_{i} )}^{2}}{λ T} )$$

It is also possible to use multilayer neural networks to model a higher-order relationship between the timestamps tᵢ and tⱼ. With the proposed method there can be a significant lower computational cost.

Another idea is the usage of a multihead self-attention model with relative time embedding for unsupervised learning of multivariate timeseries.

An unsupervised representation learning method is used to account for multivariate irregular-sampled timeseries to learn representations associated with time, which is ideal for pre-training of predictive maintenance tasks. With unsupervised pre-training, the model can first be pre-trained on a data-rich task without the expensive labels to be used in predictive maintenance.

In case of unaligned irregular-sampled multivariate timeseries, where the sampling time at each dimension may not be well-aligned, an imputation method can be performed to fill the missing values in the input and/or normalization for each dimension using standard normalization. In some embodiments a simple linear interpolation is used to interpolate the missing value according to two adjacent samples observed in the same dimension, so that the missing value is replaced by

$${x}_{i , m} = {x}_{i , m - 1} ( 1 - \frac{{t}_{m} - {t}_{m - 1}}{{t}_{m + 1} - {t}_{m - 1}} ) + {x}_{i , m + 1} ( 1 - \frac{{t}_{m} - {t}_{m - 1}}{{t}_{m + 1} - {t}_{m - 1}} )$$

In some embodiments other imputation methods can also be used, such as gaussian mixture models and GANs.

The representation learning model uses an encoder-decoder transformer in combination with the previously described relative time embedding. The time embedding may be shared across all self-attention layers. The unsupervised pre-training task can be performed by randomly masking out input series by a certain percentage (e.g., approximately 15% or 0.15) and reconstructing the corrupted parts of the input series as discussed in Devlin et al., “Bert: Pre-training of deep bidirectional transformers for language understanding”, arXiv preprint arXiv: 1810.04805 (2018). In contrast to Devlin et al. the method here, for a random timestamp tₘ to be masked out, all input dimensions x_{i,m} where iϵ[0, d-1] are replaced by the value of the timestamp tₘ.

Typically, the target output series will not be the fully reconstructed into the uncorrupted input series, but a vector of each corrupted timestamp tₘ followed by the reconstructed corrupted timeseries at this time stamp (x_{0, m}, . . . , x_{d-1, m}). This design avoids self-attention over long sequences in the decoder which in turn allows to reconstruct the full input series in a computationally efficient manner.

The loss (e.g., mean squared error or MSE loss) may be calculated only on the masked values. To improve performance, instead of naively choosing the masked-out timestamp following a Bernoulli distribution, in some embodiments a consecutive span of timeseries can be masked out with an average length a as a tunable hyperparameter, where a may be chosen to be greater than or equal to 3. With this the trivial prediction task to predict one missing value in between of two observed values can be avoided.

Another idea involves a label-efficient multitask learning solution for predictive maintenance with proposed unsupervised learning as pre-training.

Different from multitask learning and unsupervised pre-training which is usually used in the domain of NLP and computer vision (CV), a novel multitask framework for the target predictive maintenance tasks of anomaly detection, classification of failures and prediction of remaining useful life (RUL) using unsupervised representation learning is proposed.

With this, the method is able to perform unified multitask learning for predictive maintenance, especially in the case of multivariate irregular-sampled timeseries.

Multi-task learning has been successful in a large variety of domains to achieve superior performance by jointly training multiple related tasks, from natural language processing, speech recognition and acoustic modelling, to computer vision and biomedical applications. Since the three down-stream predictive maintenance tasks are very much related, a unified multi-task learning framework is proposed to fine-tune the pre-trained model jointly and to select the best checkpoint for model deployment for each individual task.

The multi-task learning typically requires the individual task datasets to be mixed together as new inputs, and a joint loss function is designed with weights (μₐ, μ_{c}, μᵣ) for each individual task loss (Iₐ, I_{c}, Iᵣ for anomaly detection, classification and RUL prediction respectively) fixed by grid-search. The total loss function is:

$$L = {μ}_{a} {l}_{a} + {μ}_{c} {l}_{c} + {μ}_{r} {l}_{r}$$

For the anomaly detection task some “future” input series is masked out, and the predicted sequence \hat{x} from the decoder is trying to recover the entire timeseries. The result is compared with the original input x. The loss function Iₐ is the MSE loss between the predicted series \hat{x} and the original series x, where M represents the number of samples in the relevant timespan. Note that the anomaly detection loss is only computed on timestamps that are associated with normal operation of the device under surveillance.

$${l}_{a} = \frac{1}{M} {\sum }_{i = 1}^{M} {( {\hat{x}}_{i} - {x}_{i} )}^{2}$$

During testing, given the entire input timeseries, an anomaly is determined by whether at a certain timestamp tₘ the MSE at that time between the predicted series and the original series exceeds a predetermined threshold. The threshold can be determined using extreme value theory.

For the classification task, a label array y can be given and the output from the decoder is concatenated with a new vector. This can be passed through a softmax function to output the distribution over classes for each relevant timestamp. The loss function I_{c} may be chosen to be the cross-entropy loss between label y at time tₘ for class h and the predicted distribution ŷtₘ,h.

$${l}_{c} = - {\sum }_{h = 1}^{H} {y}_{{t}_{m} , h} log {\hat{y}}_{{t}_{m} , h}$$

During testing, given the entire input timeseries, the output contains a vector of prediction ŷ on whether each sample of the input series indicates a failure and what this failure potentially is.

For the RUL prediction task, the interested future time stamps with failures are masked out and the input contains only normal operational data. The output decoder predicts future timeseries concatenated with a new vector which is passed through a softmax function to output a distribution over binary classes (failure, non-failure).

The loss function Iᵣ may be chosen to be the cross-entropy loss between a binary class label y at time tₘ and the predicted distribution ŷtₘ.

$${l}_{r} = - ( {y}_{{t}_{m}} log {\hat{y}}_{{t}_{m}} ) + ( 1 - {y}_{{t}_{m}} ) log ( 1 - {\hat{y}}_{{t}_{m}} )$$

During testing, the input series includes some past data samples, and some relevant future timestamps. The decoder outputs a vector of prediction ŷ on whether the machine at the relevant future timestamp will fail, the RUL is thus the temporal difference between the future time stamp and the current time stamp.

Overall the proposed solution is a framework for label-efficient predictive maintenance with irregular-sampled multivariate timeseries. Specifically, an efficient relative time embedding is used in handling the irregular-sampled timeseries incorporated with domain-specific knowledge and used for multi-head self-attention models.

An unsupervised representation learning method for irregular-sampled multivariate timeseries using multi-head self-attention with the proposed relative time embedding is used, as well as the proposed representation learning task and input/output format.

A unified label-efficient multi-task learning framework is used for jointly training multiple downstream tasks with the proposed representation learning task as pretraining, including anomaly detection, failure classification and RUL prediction.

Usually in real-world environments, normal-operation sensory data is abundant, but failure labels are extremely expensive (in terms of effort and cost). Pre-training may be conducted on unsupervised data-rich tasks without labels before being fine-tuned on supervised downstream tasks. This enables more general-purpose knowledge learned from the pre-trained tasks to be transferred to downstream tasks for a more label-efficient learning.

Main advantages of this disclosure include, but are not limited to the methods being able to handle multivariate, sparse, irregular-sampled, and variable length timeseries, which is ubiquitous in practical PdM datasets, and is cheaper to collect and store. In some embodiments, the methods are more label-efficient over existing PdM methods learning in a supervised way, so that they can reduce the costs of collecting a massive amount of run-to-failure labelled datasets. In some embodiments, the methods include deep learning models that are highly expressive over traditional timeseries prediction or traditional machine learning such as kernel methods. In some embodiments, the methods work for multiple PdM tasks (anomaly detection, failure classification, and RUL prediction), and the tasks are learned simultaneously in a multi-task learning way to improve joint performance and to share the labelled dataset. In some embodiments, the methods can potentially work for other generic tasks with irregular-sampled timeseries as inputs.

Some embodiments can potentially be used to learn representations from multivariate timeseries and fine-tuned with supervised downstream tasks in a great variety of domains and applications. Applications for this disclosure include, but are not limited to, mobile robotics, where the sensory data and GPS signals can be collected as a timeseries and used for localization, activity classification, and event detection.

Similarly, the localization, activity classification, and event detection tasks are also of great importance for healthcare applications with multi-modal biomedical sensory data collected as timeseries.

In a broader context, for smart city applications, from city planning to logistic service distribution, from transportation policy making to customer-oriented last-mile delivery, knowledge learned from multivariate timeseries such as GPS and telecommunications data (which are normally irregular-sampled due to the scales of data collection) are fundamental to all big questions asked, including accessibility, livability, sustainability, productivity and wellbeing.

### BRIEF DESCRIPTION OF THE DRAWINGS

Embodiments of the invention are described in more detail with reference to the accompanying schematic drawings.

FIG. 1 depicts an embodiment of relative time embedding;

FIG. 2 depicts an embodiment of a self-attention module in an encoder-decoder transformer model;

FIG. 3 depicts an embodiment of the encoder-decoder transformer model configured for an unsupervised first training; and

FIG. 4 depicts an embodiment of the encoder-decoder transformer model configured for a second training.

### DETAILED DESCRIPTION

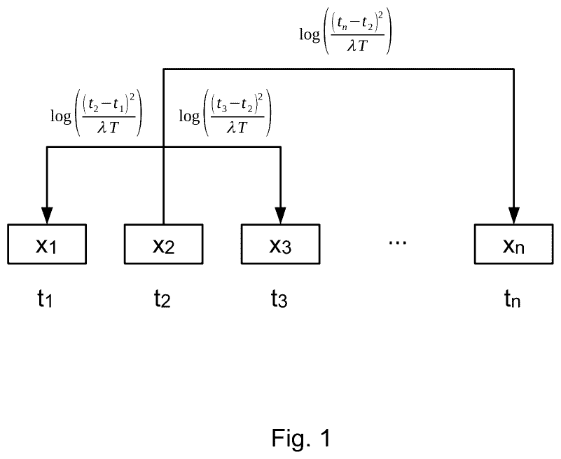

Referring to FIG. 1, a relative temporal embedding or relative time embedding is described. Timeseries data having a plurality of entries i=1, 2, 3, . . . , n are depicted. Each entry includes a time stamp t₁, t₂, t₃, . . . , tₙ and observation data x₁, x₂, x₃, . . . , xₙ. The observation data can be a single valued or multi-dimensional. Typical observation data may include, but are not limited to, temperature, power consumption, voltage, current, torque, and any other sensory data that can be useful for predictive maintenance for a specific device under surveillance.

The observation data are gathered by corresponding sensors that are attached to the device under surveillance. Due to the type of gathering of the observation data, the timeseries data is usually not continuous, but rather irregularly sampled. The timeseries data acquired and embedded like this does not include any labels.

The temporal embedding is done using a logarithm of a square of the time difference between each entry. The time difference is divided by predetermined constants λ and T. λ is a scale factor that is chosen to be about the smallest sampling interval in the timeseries data. With this, time differences that are similar to the smallest sampling interval are grouped closer together in the abstract embedding space.

Constant T includes domain specific knowledge of the device under surveillance in the form of an operational cycle. E.g., if the device under surveillance has a pre-known operation cycle, such as start-up, running, switch-off that is the same over a constant time interval (e.g., a day), T is chosen to correspond to that time interval. With this, the points in time that are periodic and occur at about the same time each operation cycle are again grouped together in the abstract embedding space.

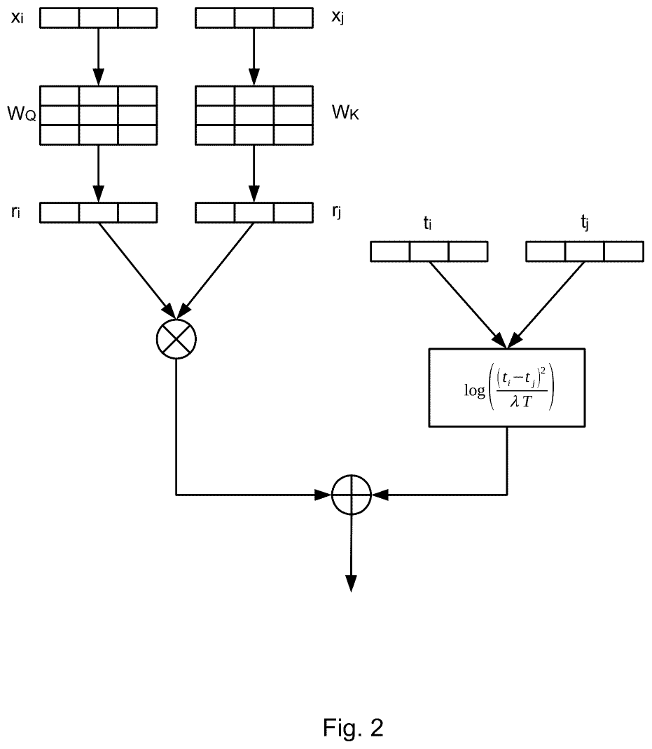

Referring to FIG. 2, a representation learning model that processes the timeseries data that were embedded is described in more detail. The representation learning model is configured as a transformer model, which includes a query matrix W_{Q} and a key matrix W_{K}.

In the left branch, observation data xᵢ and xⱼ that are each associated with different timestamps tᵢ and tⱼ are multiplied by the query and key matrices W_{Q}, W_{K}, respectively. The results rᵢ, rⱼ are multiplied together.

Furthermore, the time difference between the two timestamps tᵢ and tⱼ is squared, divided by λ for scaling and by T for periodic phenomena. If there is no pre-known cycle T, then the time difference is not squared and T is not used. The result of the logarithm is added to the result of the other branch. With this the timeseries data are embedded relative in time, which is used for further training and processing.

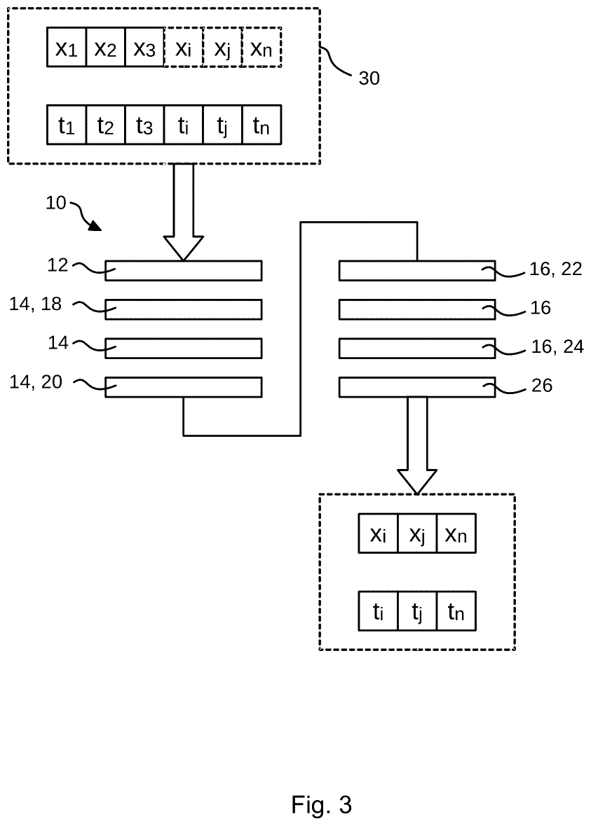

Referring to FIG. 3, a transformer model 10 is depicted. The transformer model 10 includes an input layer 12. The input layer 12 is configured as a fully-connected network.

The transformer model 10 includes a plurality of encoder layers 14 and a plurality of decoder layers 16, e.g., three encoder/decoder layers. The number of encoder layers and decoder layers need not be identical but is in an example embodiment.

A first encoder layer 18 is connected to the input layer 12. A last encoder layer 20 is connected to a first decoder layer 22. The data is passed from the first encoder layer 18 to the last encoder layer 24 via another encoder layer. The data is then further passed from the first decoder layer 22 to the last decoder layer 24.

The transformer model 10 may include an output layer 26. The output layer 26 receives the data from the last decoder layer 24. The output layer 26 may be configured as a fully-connected network.

The transformer model 10 is trained in a first training as described below. Timeseries data 30 having a plurality of timestamps t₁, t₂, . . . , tₙ. and associated observation data x₁, x₂, . . . , xₙ are obtained, e.g., from a previous measurement. A plurality of temporally consecutive observation data xᵢ, xⱼ, xₙ are masked, i.e., removed from the dataset.

The timeseries data 30 are embedded and fed to the transformer model 10. The transformer model 10 is trained with an unsupervised training method to recover the previously masked observation data that are associated with the corresponding timestamps tᵢ, tⱼ, tₙ. It should be noted that only the masked observation data are recovered. This step is also designated as pre-training.

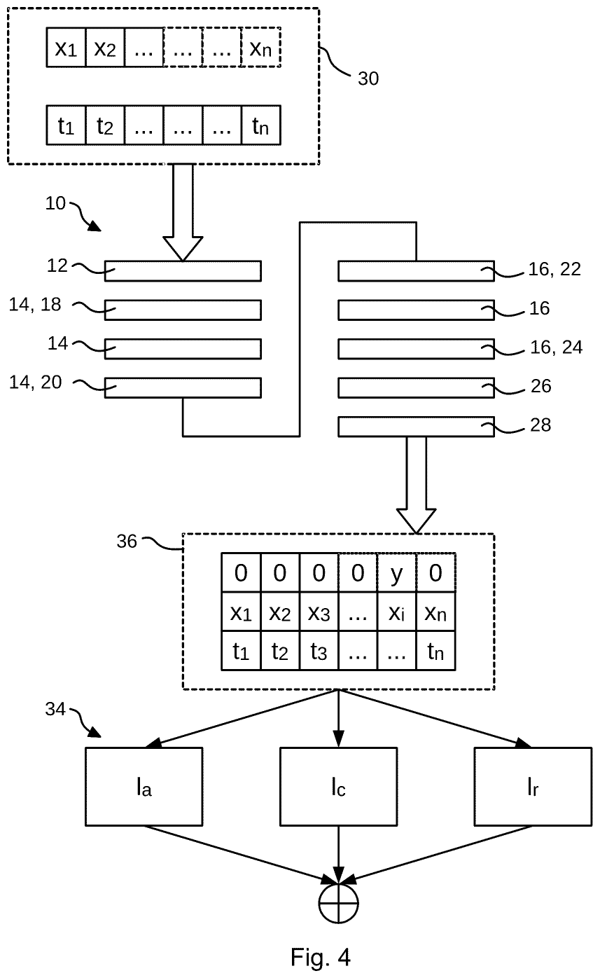

Referring to FIG. 4, a fully-connected layer 28 is connected to the output layer 26 of the transformer model 10. The fully-connected layer 28 is a softmax layer performing the softmax function on the recovered timeseries data 32.

Furthermore, a plurality of loss models 34 are connected to the fully-connected layer 28. The loss models 34 are chosen from a group of loss functions that consists of an anomaly detection function Iₐ, a classification loss function I_{c}, and a residual useful life loss function Iᵣ. A total loss function L is calculated from a, weighted, sum of the individual loss functions.

It should be noted that in this step, recovered timeseries data 32 may be labelled. A label y may be obtained by someone performing maintenance on the device under surveillance and assigning the label y to a particular timestamp. The label y may be indicative of a specific error or problem that occurred in the device under surveillance. In another embodiment, the label y may be added automatically, when a certain threshold of a physical parameter of the device under test was exceeded or subceeded, e.g., a temperature threshold, a torque threshold, a power consumption threshold.

It should be noted that the number of labels y within the timeseries is small and only a few timestamps will have a label y. As a default, i.e., no label, the label y can be set to 0.

Using the sparsely labelled timeseries data and the total loss function L, a second training of the transformer model 10 is performed. This is also called fine-tuning of the transformer model 10.

After training, the transformer model 10 is capable to determine predictive maintenance data that is indicative of anomalous operation of the device under surveillance, a class of failure/error occurring in the device under surveillance, and/or of the remaining useful life of the device under surveillance.

With the measures disclosed herein, multiple predictive maintenance tasks (anomaly detection, failure classification and/or prediction of remaining useful lifetime) can be determined given a multivariate irregular-sampled sparsely-labelled and/or variable-length timeseries data. The timeseries data are collected from sensors to monitor the conditions of a device under surveillance. The idea allows to save maintenance costs by increasing the performance of predictive maintenance tasks using less optimal data without abundant expensive labels. The idea can also be used when in practice only one or two of the predictive maintenance tasks are to be performed. The idea can also be applied to better data (univariate, regular-sampled, lots of labels, or standardized length).

### REFERENCE SIGNS

10 transformer model
12 input layer
14 encoder layer
16 decoder layer
18 first encoder layer
20 last encoder layer
22 first decoder layer
24 last encoder layer
26 output layer
28 fully-connected layer
30 timeseries data
32 recovered timeseries data
34 loss model

1. A computer-implemented method for training a representation learning model to be able to determine predictive maintenance data from irregular-sampled, and variable-length timeseries data that is indicative of a state of a device under surveillance, the method comprising:
a) obtaining or providing unlabeled timeseries data that are indicative of a state of a device under surveillance and that include a plurality of entries, each entry including a timestamp and at least one piece of observation data that is indicative of a physical property of the device under surveillance and that is associated with the timestamp;
b) performing an embedding of the timeseries data of a) that generates embedded timeseries data that are indicative of the relative temporal distance of the entries relative to each other;
c) performing a first training of the representation learning model, the representation learning model having at least one encoder layer and at least one decoder layer, wherein a last encoder layer feeds into a first decoder layer, by masking in the embedded timeseries data a predetermined number of temporally consecutive pieces of observation data so as to obtain masked embedded timeseries data and training the representation learning model to recover the masked consecutive pieces of observation data;
d) attaching to the representation learning model a fully-connected layer that normalizes an output of the representation learning model and feeds the normalized output to at least one loss model that is indicative of a specific predictive maintenance task; and
e) performing a second training of the representation learning model based on the at least one loss model of d) and sparsely labelled timeseries data in order to obtain a trained representation learning model configured to determine predictive maintenance data.

2. The method according to claim 1, wherein the unlabeled timeseries data are gathered by a sensor device that is arranged to measure a physical property of the device under surveillance.

3. The method according to claim 1, wherein embedding the timeseries data comprises generating directed graph data from the entries, wherein the directed graph data are structured to represent a plurality of nodes that are linked with edges, wherein a first node is assigned the observation data that are associated with a first timestamp and a second node is assigned the observation data that are associated with a second timestamp that is different from the first timestamp, and an edge connecting the first node with the second node is assigned an edge value that is indicative of the relative temporal distance between the first timestamp and the second timestamp.

4. The method according to claim 3, wherein determining the relative time difference includes calculating a logarithm of a time difference between the first and second timestamps or includes calculating a logarithm of a square of a time difference between the first and second timestamps.

5. The method according to claim 4, wherein the time difference is divided by a predetermined constant that is chosen to be equal to or smaller than a minimum sampling interval of the timeseries data.

6. The method according to claim 5, wherein the time difference is divided by another predetermined constant that is chosen to represent a time period that is present unlabeled in the timeseries data due to cyclical operation of the device under surveillance.

7. The method according to claim 1, wherein in at least one of c) or d), the representation learning model includes a fully-connected neural network layer as an input layer that gets fed with the masked embedded timeseries data and passes an output of the input layer to a first encoder layer.

8. The method according to claim 1, wherein in at least one of c) or d), the representation learning model includes a fully-connected neural network layer as an output layer that gets fed with an output of a last decoder layer and passes an output of the output layer to a loss function of a first training in case of at least one of c) or to the fully-connected layer in case of d).

9. The method according to claim 1, wherein in d), each loss model is chosen from a group consisting of a loss function that is indicative of anomalous observation data, a loss function that is indicative of a class of failure, and a loss function that is indicative of a remaining useful lifetime.

10. The method according to claim 1, wherein in d), a first loss model and a second loss model that are different from each other are chosen, wherein a multi-task training loss is determined based on a respective output of the loss models, and the multi-task training loss is used in e) for the second training.

11. A predictive maintenance method comprising:
a) gathering the timeseries data that is indicative of the physical property of the device under surveillance;
b) feeding the timeseries data to the representation learning model that was trained with the method according to claim 1; and
c) determining with the trained representation learning model the predictive maintenance data that are indicative of a maintenance related task.

12. An encoder-decoder transformer model that was trained with a method according to claim 1.

13. A data processing system comprising means for carrying out at least one, some, or all of the method according to claim 1.

14. A computer program comprising instructions which, when the program is executed by a data processing system, cause the system to carry out at least one, some, or all of the method according to claim 1.

15. A computer-readable data carrier or a data carrier signal that includes the computer program according to claim 14.
